(19) United States
(12) Patent Application Publication
(10) Pub. No.: US 2011/0038043 A1
(43) Pub. Date: Feb. 17, 2011

(54) SEGMENTED LENTICULAR ARRAY USED IN AUTOSTEREOSCOPIC DISPLAY APPARATUS

(75) Inventors: Lang-Chin Lin, Hsinchu City (TW); Wei-Liang Hsu, Taipei City (TW); Kuen Lee, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/541,977

(22) Filed: Aug. 17, 2009

(51) Int. Cl. G02B 27/22; G02B 27/12

(52) U.S. Cl. 359/463; 359/628

(57) ABSTRACT

An autostereoscopic display includes a displaying panel, having a pixel array, the pixel array having a plurality of pixel units, and each of the pixel units including multiple view zones in a specific pixel pattern. A plurality of lenticular segments, corresponding to each of the pixel units, forms a plurality of lenticular rows with a number of the lenticular segments for each of the lenticular rows. The lenticular segments in adjacent two of the lenticular rows have an offset and a side edge of each of the lenticular segments does not form a slant straight line.

### BACKGROUND OF THE INVENTION

1. Field of Invention

The present invention relates to autostereoscopic display. More particularly, the present invention relates to segmented lenticular array capable of use in autostereoscopic display.

2. Description of Related Art

The autostereoscopic display has been proposed to automatically display a 3D image when the displayed image is viewed by an observer. The displayed image includes several view-zone images. Each view-zone image has a parallax to the other view-zone image. When the two eyes of the user are observing the different view-zone images, respectively, a 3D image can be automatically observed. The observer needs not to ware the polarized glass in conventional manner. However, in order to produce multiple view-zone images, the resolution of the display panel is certainly reduced. However, the semiconductor fabrication technology has been greatly improved and the resolution of display panel has been improved by a great amount. So, the autostereoscopic display can be expected to be the next generation of display system.

FIG. 1 is a plane-view drawing, schematically illustrating a conventional autostereoscopic display apparatus with slant lenticular elements. In FIG. 1, the autostereoscopic display apparatus has a display panel 10 with the pixels 12 formed as a pixel array. The pixels 12 are in a rectangular shape. The black mask 18 is surrounding the pixels 12. The display panel 10 displays six view-zone images, as indicated by numerals 1 to 6. In other words, the one image pixel has six sub-pixels corresponding to 6 view zone. In addition, the lenticular sheet 15 with the slant lenticulars 16 by an angle α covers over the display panel 10, so that the lenticulars 16 can project the view-zone images to the specific directions for receiving by the two eyes of the observer. The pixels 12 in the dashed line A, B, or C can be respectively viewed at the same time corresponding to the different view angles. As a result, two view-zone images can produce the 3D displaying effect when viewed by both eyes at the same time. The slant lenticulars allows the resolution consumption in horizontal direction to be reduced while the resolution is shared at the vertical direction. In other words, if the lenticular is aligned at the vertical direction, the pattern with multiple view zones degrades the resolution at the horizontal direction but the vertical resolution still remains. If the lenticular is aligned a slant angle, the pixel may distributed in two or more rows. Then, the horizontal resolution can increase but the vertical resolution then decreases. The mechanism for displaying image with 3D effect is known in the art and detail is not further described.

However, for the conventional lenticular sheet 15, the side edge is a straight line and often slantingly cut pixel 12 in irregular portion. This manner would at least cause the cross-talk between the adjacent two view zones. A better design for the lenticular structure is still in need.

### SUMMARY OF THE INVENTION

The invention provides a lenticular structure in segments. The interference between the view-zone images can be at least reduced.

The invention provides an autostereoscopic display including a displaying panel, having a pixel array, the pixel array having a plurality of pixel units, and each of the pixel units including multiple view zones in a specific pixel pattern. A plurality of lenticular segments, corresponding to each of the pixel units, forms a plurality of lenticular rows with a number of the lenticular segments for each of the lenticular rows. The lenticular segments in adjacent two of the lenticular rows have an offset and a side edge of each of the lenticular segments does not form a slant straight line.

The invention provides a lenticular array, capable for use in an autostereoscopic display. The lenticular array includes a plurality of lenticular segments in a rectangular shape, arranged in a plurality of lenticular rows, each of the lenticular rows having a number of the lenticular segments. The lenticular segments in adjacent two of the lenticular rows have an offset according to a slant direction and a side edge of each of the lenticular segments forms a step structure.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a plane-view drawing, schematically illustrating a conventional autostereoscopic display apparatus with slant lenticular elements.

FIG. 2 is a plane-view drawing, schematically illustrating an autostereoscopic display apparatus with a lenticular structure, according to an embodiment of the present invention.

FIG. 3 is a perspective view, schematically illustrating the lenticular structure in FIG. 2.

FIGS. 4-7 are plane-view drawings, schematically illustrating multiple views autostereoscopic display apparatus with lenticular structures in different configuration, according to other embodiments of the present invention.

FIG. 8-9 are plane-view drawing and perspective view, schematically illustrating an autostereoscopic display apparatus with a lenticular structure in different configuration, according to another embodiment of the present invention.

### DESCRIPTION OF THE PREFERRED EMBODIMENTS

In the invention, the autostereoscopic display apparatus allows the naked eyes to observe the 3D image. For the conventional design, the multiple view zones are distributed in pixels at the horizontal direction in one pixel row. The lenticular is according arranged in vertical direction to cover the multiple pixels. In this arrangement, the horizontal resolution is reduced a lot while the vertical resolution still remains. The slant pixel pattern in accordance with the slant lenticular column can save the horizontal resolution but the vertical resolution is reduced. This means a partial of the horizontal resolution is moved to the vertical resolution. However, when the lenticular is slant, the view zones crossed by the side edge of the lenticular column are not perfectly divided, causing the crosstalk between the view zones. The present invention further uses the lenticular segments to form the slant lenticular column. Since the lenticular segments can be more properly match to the geometry of the pixels, the crosstalk between the view zones due to the edge of the lenticular column can be at least reduced.

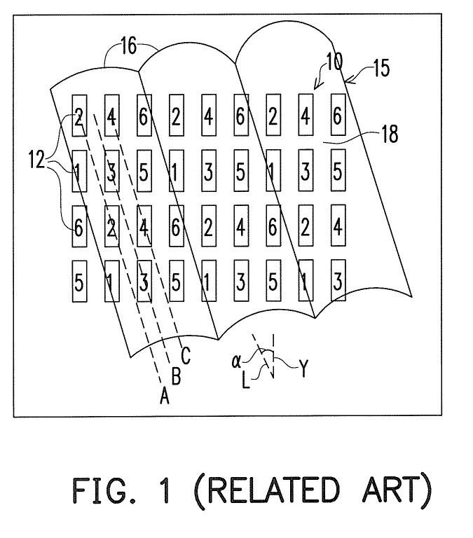

In the invention, the segmented lenticulars are proposed to form the lenticular sheet over the display panel. Each segmented lenticular horizontally covers multiple pixels corresponding to multiple view zones. When the segmented lenticulars are arranged into slant columns, the segmented lenticulars doe not cut the pixel by a slant portion as did in conventional manner shown in FIG. 1. The cross-talk between the view zones at the edge of the slant lenticular column can at least be reduced.

Several embodiments are provided for descriptions. However, the invention is not limited to the embodiments. Further, the embodiments to each other can be combined into another additional embodiment.

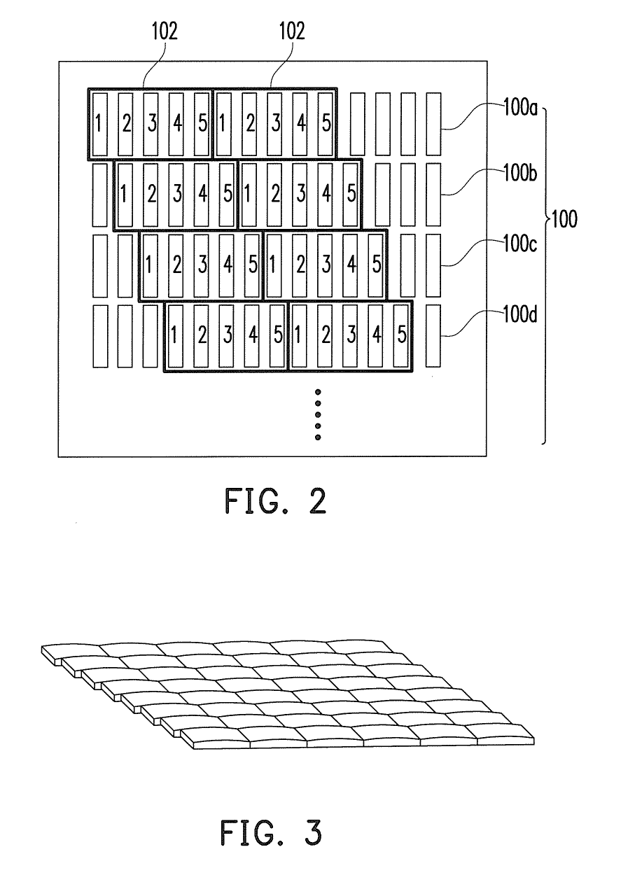

FIG. 2 is a plane-view drawing, schematically illustrating an autostereoscopic display apparatus with a lenticular structure, according to an embodiment of the present invention. In FIG. 2 as one of embodiments, the display panel 100 of the display apparatus includes a pixel array. The pixel array is also arranged into several horizontal lines or pixel rows 100a, 100b, 100c, 100d, . . . , and so on. Each pixel row has several pixels, and the pixels belonging to the same segment include multiple view zones, such as five view zones indicated by numerals 1-5. For the display with 3D effects, in order to keep more resolution in horizontal direction, the vertical resolution is then degraded. The pixel rows are arranged to be shifted by one sub-pixel in this example. When the pixels are arranged as R, G, and B strips, one pixel usually needs three sub-pixels of R, G, and B to display the actual color, the same pixel column displays the same primary color, and the sequence is in cycle of RGB, as usually known. In this example, the three pixel rows 100a, 100b, and 100c form a full pixel. This means resolution is distributed in both the horizontal and vertical directions. Taking the view zone 1 as the example, it forms a pixel with full color for the image of view zone 1. In order to produce the 3D effect, the two eyes have to view different two different view-zone images. However, if there is no the lenticular to project the different view-zone images at different locations for separately observing by the two eyes, the multiple view-zone images are mixed together. Then, no 3D effect occurs.

The present invention proposes that multiple lenticular segments 102 to compose the slant lenticular columns in corresponding to the pixel pattern for multiple view zones. As can be see, several lenticular segments 102, corresponding to each pixel unit, which includes five sub-pixels belong to five view zones 1-5, for example. The lenticular segments 102 form multiple lenticular rows corresponding to the pixel rows 100a, 100b, 100c, 100d, . . . , and so on. Each lenticular row has a number of the lenticular segments 102. The lenticular segments 102 in adjacent two lenticular rows have an offset, such as one sus-pixel in this example. As a result, side edges of the lenticular segments 102 do not form a slant straight line. The slant angle is depending the on the actual design of the pixel pattern with multiple view zones when considering the resolution loss in the vertical resolution but keeping higher resolution at the horizontal direction.

FIG. 3 is a perspective view, schematically illustrating the lenticular structure in FIG. 2. In FIG. 3, as can be see, the lenticular structure is composed by several lenticular segments, in which between each of lenticular rows have an offset, such as one sub-pixel in this.

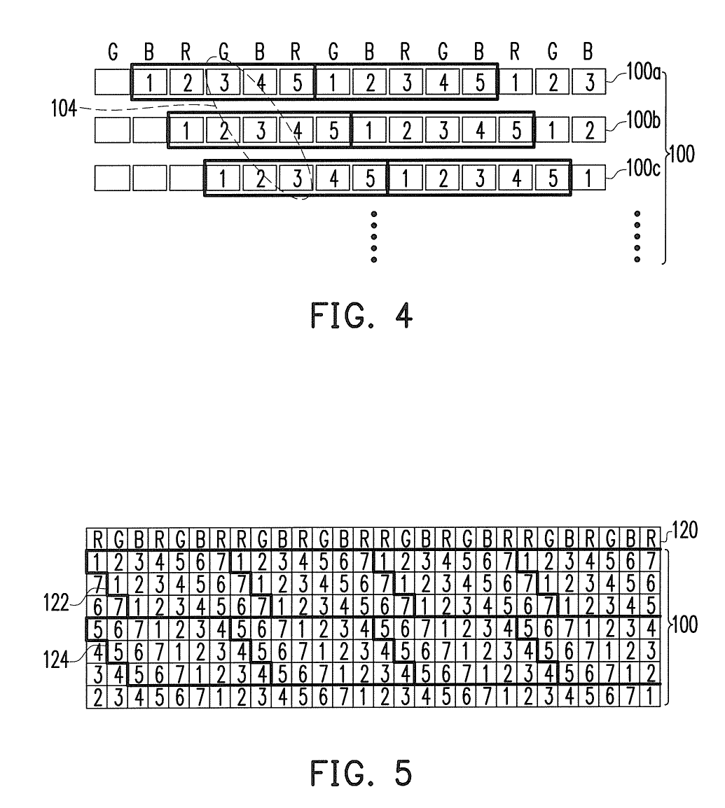

FIGS. 4-7 are plane-view drawings, schematically illustrating multiple views autostereoscopic display apparatus with lenticular structures in different configuration, according to other embodiments of the present invention. In FIG. 4, pixel pattern is arranged and the lenticular segments as indicated by rectangular region are correspondingly arranged. In this example, the primary colors of R, G, and B indicate the pixel columns, which should display the corresponding duty color. In the drawing, only two slant lenticular columns are shown. A full pixel, such as the pixel belonging to the view zone 3, is indicated by the dashed closing line 104. However, the lenticular segments in the pixel row 100b are shifted by an offset from the pixel row 100a. The offset in this example is one sub-pixel. However, the offset can even be more then one sub-pixel or even with a fraction, such as 0.5 sub-pixels, 1.5 sub-pixels or other quantity. In this example, for the design of five view-zone images, the resolution in horizontal direction can be just reduced by a factor of 5/3 but not 5. However, the vertical resolution is reduced by factor of 3.

In FIG. 5, for the further example of the pixel pattern design with 7 view zones, the display panel 100 has the multiple pixel columns to display the primary colors of R, G, and B as indicated at the region 120, which is for description but not actually exist in the display panel 100. In this example, three lenticular segments form a lenticular group 122 as a full pixel with RGB and indicated by the thick line. The pixel pattern for display the 7 view-zone images can be regular in cycle manner. The next lenticular group 124 for another full pixel is the same arrangement but formed by the next three pixel rows. Here, only two lenticular groups 122, 124 are shown. Actually, the same arrangement is applied to the whole display panel 100. The resolution in horizontal direction is reduced by a factor of 7/3 instead of usual factor of 7. However, the vertical resolution is reduced by factor of 3 because the lenticular group 122 of a full pixel takes three pixel rows. Each lenticular segment covers over 7 sub-pixels for 7 view zones. For one lenticular group, it has the same offset by one sub-pixel. The next three lenticular rows form the lenticular group 124 but the first one of the lenticular row is shifted back the same position by opposite direction with two sub-pixels. In other words, the offset can be not constant for the whole display panel 100 and the offset direction can be positive and negative in mixed manner.

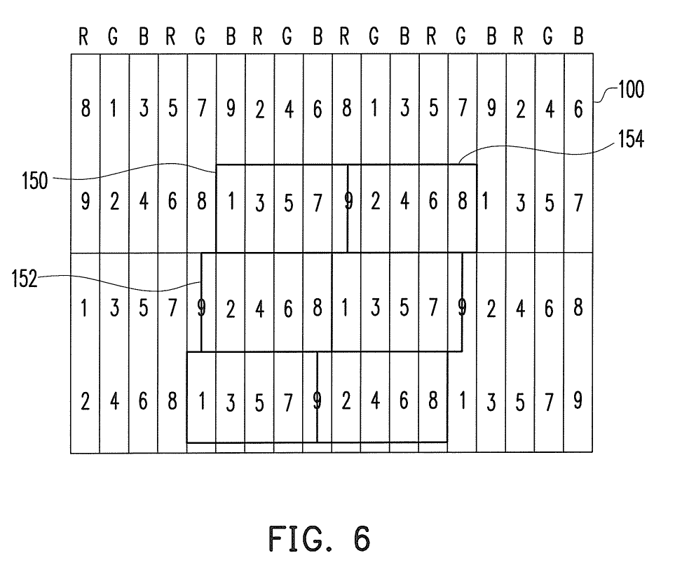

In FIG. 6, it is another arrangement for the pixel pattern for 9 view zones in a larger size of display panel 100. The sub-pixels corresponding to the 9 view zones are regularly distributed in two pixel rows by alternating sequence. For this dine of the display panel 100 with the pixel pattern, the full pixel with RGB is distributed in three pixel rows. In accordance with the pixel pattern, the lenticular segments 150, 152, 154, . . . , in this example are designed to cover 4.5 sub-pixels for each and two adjacent lenticular segments 150, 154 in the same row form together. As a result, the offset for the lenticular rows is 0.5 sub-pixel. The resolution in horizontal direction is reduced by a factor of 3 while the vertical resolution id also reduced by a factor of 3. This embodiment also shows that the offset can be a fractional of sub-pixel. Since the offset depends on the resolution in design, the offset can be accordingly adjusted without limited to a specific quantity. However, the present invention uses the lenticular segment, such as the rectangular lenticular segment, to compose the while lenticular column. The lenticular segments at side edge are not a continuous straight line and can reduce the crosstalk of residual image in different view zones.

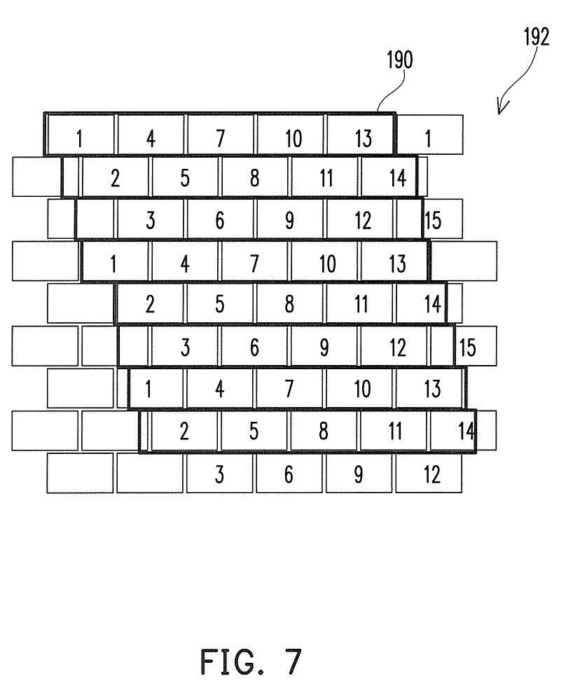

In FIG. 7, the RGB sub-pixels are arranged as a pixel array 192, according the known delta manner by 15 view zones, for example. For this example of arrangement of pixel array 192, each lenticular segment 190 can, for example, covers 5 horizontal view zones and covers one pixel in vertical direction. For the suitable choice of the slant angle, for example, each next row of the lenticular segments is offset by 1/6 sub-pixel in width. As a result, the horizontal resolution is reduced by a factor of 10/3 and the vertical resolution is reduced by a factor of 9/2.

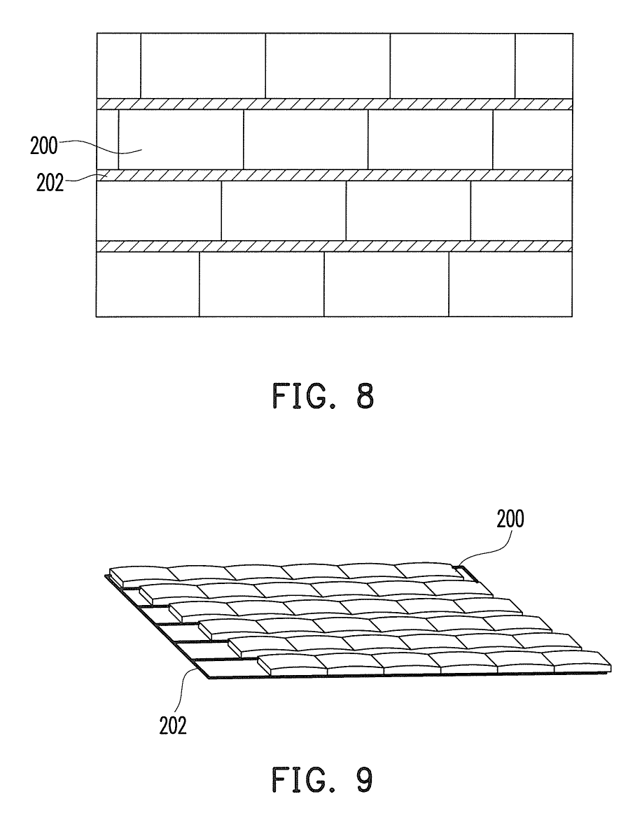

FIGS. 8-9 are plane-view drawing and perspective view, schematically illustrating an autostereoscopic display apparatus with a lenticular structure in different configuration, according to another embodiment of the present invention. In FIG. 8, in order to have better separation, the interface region between two lenticular rows 200 can be, for example, further implemented with a black strip region 202. The width of the black strip region 202 can be, for example, about 20 microns or in a range from one micron up to 100 microns. This black strip region 202 can also at least reduce the crosstalk between lenticular rows for projecting the view-zone images.

In FIG. 9, as shown in perspective view, there is a gap between adjacent two lenticular rows 200 corresponding to the lenticular structure in FIG. 8. Each of the lenticular rows 200 is composed by multiple lenticular segments. The black strip region 202 is located within the gap between adjacent two lenticular rows 200.

The lenticular sheet of the invention can be applied to the display panel of a display apparatus, for example. However, the lenticular sheet of the invention actually can be applied to any other use when it needs this lenticular structure.

Then, an autostereoscopic display can include a displaying panel 100, having a pixel array, the pixel array having a plurality of pixel units, and each of the pixel units including multiple view zones in a specific pixel pattern. A lenticular sheet has multiple lenticular segments, which are corresponding to each of the pixel units and form a plurality of lenticular rows. Each of the lenticular rows has a number of the lenticular segments. The lenticular segments in adjacent two of the lenticular rows have an offset and a side edge of each of the lenticular segments does not form a slant straight line.

In a further embodiment for the autostereoscopic display, for example, the offset is an integer of pixel width or a fractional of pixel width.

In a further embodiment for the autostereoscopic display, for example, a distribution of the lenticular segments in a column direction includes a plurality of slant lenticular columns, wherein each of the slant lenticular columns has a step structure caused by the side edge of each of the lenticular segments.

In a further embodiment for the autostereoscopic display, for example, the side edge of each of the lenticular segments is perpendicular to a row direction of the lenticular rows.

In a further embodiment for the autostereoscopic display, for example, each of the lenticular segments covers a plurality of pixels in an integer number.

In a further embodiment for the autostereoscopic display, for example, each of the lenticular segments covers a plurality of pixels in a non-integer number.

In a further embodiment for the autostereoscopic display, for example, each of the lenticular segments covers at least one pixel in column direction.

In a further embodiment for the autostereoscopic display, for example, it further comprises a black strip region between adjacent two of the lenticular rows.

In a further embodiment for the autostereoscopic display, for example, the black strip region has a width of about one micron to about 100 microns.

In a further embodiment for the autostereoscopic display, for example, it further comprises an electro-optical (EO) device to switch lenticular segments between 3D display and 2D display.

In a further embodiment for the autostereoscopic display, for example, the EO device includes multiple segments corresponding to the lenticular segments.

In a further embodiment for the autostereoscopic display, for example, the displaying panel comprises liquid crystal display (LCD) panel, organic light emitting diode (OLED) panel, or plasma display panel (PDP).

In a further embodiment for the autostereoscopic display, for example, the offset is constant or not a constant. The offset direction may also be the same or not all the same.

For an embodiment of the lenticular array in a lenticular sheet, the lenticular array includes a plurality of lenticular segments in a rectangular shape, arranged in a plurality of lenticular rows, each of the lenticular rows having a number of the lenticular segments. The lenticular segments in adjacent two of the lenticular rows have an offset according to a slant direction and a side edge of each of the lenticular segments forms a step structure.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An autostereoscopic display, comprising:
a displaying panel, having a pixel array, the pixel array having a plurality of pixel units, and each of the pixel units including multiple view zones in a specific pixel pattern; and
a plurality of lenticular segments, corresponding to each of the pixel units, arranged in a plurality of lenticular rows with a number of the lenticular segments for each of the lenticular rows, wherein the lenticular segments in adjacent two of the lenticular rows have an offset and a side edge of each of the lenticular segments does not form a slant straight line.

2. The autostereoscopic display of claim 1, wherein the offset is an integer a pixel width.

3. The autostereoscopic display of claim 1, wherein the offset is a fractional of a pixel width.

4. The autostereoscopic display of claim 1, wherein a distribution of the lenticular segments in a column direction includes a plurality of slant lenticular columns, wherein each of the slant lenticular columns has a step structure caused by the side edge of each of the lenticular segments.

5. The autostereoscopic display of claim 1, wherein the side edge of each of the lenticular segments is perpendicular to a row direction of the lenticular rows.

6. The autostereoscopic display of claim 1, wherein each of the lenticular segments covers a plurality of pixels in an integer number.

7. The autostereoscopic display of claim 1, wherein each of the lenticular segments covers a plurality of pixels in a non-integer number.

8. The autostereoscopic display of claim 1, wherein each of the lenticular segments covers at least one pixel in column direction.

9. The autostereoscopic display of claim 1, further comprising a black strip region between adjacent two of the lenticular rows.

10. The autostereoscopic display of claim 9, wherein the black strip region has a width of about one micron to about 100 microns.

11. The autostereoscopic display of claim 1, further comprising an electro-optical (EO) device to switch lenticular segments between 3D display and 2D display.

12. The autostereoscopic display of claim 11, wherein the EO device includes multiple segments corresponding to the lenticular segments.

13. The autostereoscopic display of claim 1, wherein the displaying panel comprises liquid crystal display (LCD) panel, organic light emitting diode (OLED) panel, or plasma display panel (PDP).

14. The autostereoscopic display of claim 1, wherein the offset is constant.

15. The autostereoscopic display of claim 1, wherein the offset is not a constant and a direction of the offset is not all the same.

16. A lenticular array, capable for use in an autostereoscopic display, comprising:
a plurality of lenticular segments in a rectangular shape, arranged in a plurality of lenticular rows, each of the lenticular rows having a number of the lenticular segments, wherein the lenticular segments in adjacent two of the lenticular rows have an offset according to a slant direction and a side edge of each of the lenticular segments forms a step structure.

17. The lenticular array of claim 16, wherein a distribution of the lenticular segments in a column direction includes a plurality of slant lenticular columns, wherein each of the slant lenticular columns has a step structure caused by the side edge of each of the lenticular segments.

18. The lenticular array of claim 16, wherein the side edge of each of the lenticular segments is perpendicular to a row direction of the lenticular rows.

19. The lenticular array of claim 16, wherein each of the lenticular segments covers a plurality of pixels in an integer number.

20. The lenticular array of claim 16, wherein each of the lenticular segments covers a plurality of pixels in a non-integer number.

21. The lenticular array of claim 16, wherein each of the lenticular segments covers at least one pixel in column direction.

22. The lenticular array of claim 16, wherein the offset is constant.

23. The lenticular array of claim 16, wherein the offset is not a constant and a direction of the offset is not all the same.
